(19) United States
(12) Patent Application Publication
(10) Pub. No.: US 2011/0088326 A1
(43) Pub. Date: Apr. 21, 2011

(54) SPACE ENCLOSURE SYSTEM

(75) Inventor: Neil Ingram, Malaga (ES)

(73) Assignee: CLEAR GLASS CURTAIN SL, Malaga (ES)

(21) Appl. No.: 12/990,147

(22) PCT Filed: Jan. 30, 2009
(86) PCT No.: PCT/ES2009/000047

§ 371 Date: Oct. 28, 2010

(30) Foreign Application Priority Data
Feb. 1, 2008 (ES) P200800273

(51) Int. Cl. E05D 15/58

(52) U.S. Cl. 49/177

(57) ABSTRACT

An enclosure system includes a set of independent panels (1 and 2) which slide longitudinally along an upper guide rail (11) and a lower guide rail (12), in which the weight of each panel rests uniformly and longitudinally along the length of the lower rail (12). The upper rail (11) has a rectangular cross-section and an opening (25) in the lower part thereof. The lower rail (12) is rectangular and the upper part thereof is partially open (24) and delimited by two equidistant sides provided with notches (20) in which Teflon strips (4) are engaged, the panels (2) moving on the strips. Each of the panels (1 and 2) includes a tempered glass pane (10). The upper part of the rotation shaft includes a T-guide screw (5), a rotation guide (6) and a cylindrical part (7) and the lower part thereof includes a screw (16) and a lower guide (15).

### TECHNICAL AREA

This invention makes reference to a system of closure of panels; its aim is to divide, isolate or compartmentalize spaces in houses, offices, shops, etc. by means of a flexible system based on glass and aluminum. For this reason, this invention fits into the technical area of construction, more precisely in the area of enclosures to divide spaces and to enclose spaces on terraces, balconies, rooms, etc.

### CONDITION OF THE TECHNICAL AREA

Within the technical area, there are well known systems of enclosure mainly based on a set of panels hanging from a rail on the roof and that move with the help of bearings and other mechanical elements. These devices present several problems and limitations derived from the gears and bearings, and also from the fact that the weight of the panels rests on the upper rails and not on the floor. In all of these systems, the bearings and gears wear out, fact that makes it necessary to carry out a periodical maintenance of them. Moreover, the weight of the panels can result on malformations on the upper rail, in which the weight of these devises rests, which considerably limits the useful life of the enclosure systems. Examples of these systems are described on patent WO 90/12128 or in the French document FR2.557.624.

The invention subject matter of this patent aims to solve the problems mentioned above by developing an enclosure system in which the weight of the panels rests on the floor, thus eliminating bearings and gears.

### EXPLANATION OF THE INVENTION

This invention aims to solve the problems that arise from the structures that constitute the systems of enclosure of both, outer spaces, as for example terraces, and inner spaces, like those structures used to divide meeting rooms. The solution presented hereby is based in a set of independent panels that move individually, guided by an upper and a lower guide, and in which the weight of each of the panels rests longitudinal and uniformly throughout the lower rail. This structure aims to avoid places in which there is an excessive pressure, as well as mechanical elements vulnerable to suffer failures due to bearings.

This system is composed by a door and a set of panels. Generally, the door is the last panel and it does not move longitudinally from the pick-up position. The door setting is similar to the one of the rest of the panels, though it also includes a system of closure. The independent panels are made up of toughen glass, between 10 and 30 mm thick. The panels include a set of elements that allow them to move along a couple of rails located one in front of the other, on the roof and the floor of a room, terrace, shop, etc. The panels move along these rails with the help of some guides, and the weight of the whole structure only rests on the floor. For this reason, the only function of the upper rail is to guide the movement of each panel. Both panels are independent, and can be moved by a person along the rails. Besides, they can rotate along the axle made up by one of the lateral sides of the panel in such a way that it can be placed in a perpendicular position to the rails. The rotation or opening of the panels shall occur at the end of the rails, that is, near the walls, with the purpose of picking them up. In this way, the panels are picked up in one of the edges of the upper and lower rails that coincide with the walls. When the panels are picked up, these are placed at right angles of the rails. On the other side, the space enclosure shall occur when the panels are extended.

Between these two extreme positions it is possible to include a whole set of possibilities that will depend on the user.

The upper end of the glass is protected by an aluminum frame that has two end arms stuck to the glass and a trapezoid-shaped base, the upper side of which is open and corresponds to the big side, while the base is the small one and coincides with the base of the arms of the frame. Because of the opening of the trapezium, a set made up of three pieces comes out, which make up the upper side of the rotation axle. These three pieces are:
a) A guide-screw made up of stainless steel and with the shape of a “T”; the head of the “T” screw is oval and has 2 elongated and straight sides.
b) A plastic spin guide with a circular shape and located inside the rail. The guide is a sole piece made up of polyamide or a similar material and it consists of two cylindrical “floors” of different size. The first cylinder that makes up the base of the guide has a larger diameter and is in touch with the walls of the upper rail. The cylindrical upper floor has a smaller diameter. A circular inner opening goes through its axle into the spin guide. This opening allows the entrance of the T guide-screw, being the diameter of the lower circular opening smaller than the head of the T guide-screw.
c) A cylindrical plastic component that is in touch with the sides of the frame and the lower side of the cylinder of the spin guide acting as stop between the two of them; this component is bored on its axle so as to allow the entrance of the T guide-screw.

The head of the guide sets together with the joint of the spin guide, and the base of this T screw goes through the hollow made in the upper side of the trapezium of the frame that protects the crystal and screws into a sheet metal located inside the hollow of the frame trapezium. This sheet metal is elongated and has three hollows of identical diameter placed along the longitudinal axle of the piece. The sheet metal is rectangular; three of its sides are straight and the other one is slightly curved. The T screw drives into the perforation of the sheet metal which is nearest to the curved side, which is also the nearest side to the prominent end of the panel or the door. This upper sheet metal is located in a determined place along the hollow of the frame trapezium with the help of two stud screws without head that drive into the ends of the sides that make up the opening to the hollow of the trapezium, and on the other two threaded hollows of the sheet metal. The upper sheet metal's function is to keep the frame and the upper rail together with the help of the set of pieces that make up the rotation axle of the upper part. These pieces are not sized to support the weight of the panel, since the panel shall rest in the base of the device. For this reason, the T screw, together with the stud screws, fasten the panel to the upper guide rail with the help of the third cylindrical piece.

The upper rail is of rectangular or squared section; one of its sides is partially closed, and, through its opening, the elements that constitute the spin axle of the panels previously explained are introduced. The opening is limited by the equidistant sides of the rail. The upper rail is attached to the roof by means of nails, screws or other similar elements that drill a slot in the shape of a channel located along the axle in the inner face opposite to the guide rail, thus enabling the introduction of the screws that attach the rail to the roof.

The lower side of the glass is protected by a lower aluminum frame similar to the upper one. The glass is attached to this frame in the same way that it is attached in the upper side. The upper side of the frame includes the arms of the frame, each of which counts with small prominences on the inner face and a base where the weight of the glass rests. From the base of the frame some sides come out; these constitute the trapezium and function as a mounting structure, since they rest on top of a sleeve of the lower rail frame, which is also made up of aluminum. The lower side of the trapezium is open and corresponds to the larger side, whereas the base corresponds to the smaller one. Within the trapezium a sheet metal similar to the one introduced in the upper side of the panel is placed. A stainless steel screw is driven into the sheet metal and it goes through a component called the lower guide, made up of polyamide or a similar material, which allows the longitudinal movement along the lower rail. This lower rail is a sole piece and it comprises four “floors” that make up the cylinders of different shape:
A cylinder with a larger diameter that makes up the base of the lower guide and which is in touch with the walls of the lower rail.
Another cylinder that functions as step with the lower and upper cylinder.
Finally, from the top of the step cylinder the fourth cylinder protrudes, the diameter of which is slightly larger than the upper opening of the lower guide rail. The cylinder adapts to the upper opening of the lower guide rail.

The lower rail section is rectangular or squared shaped, and its base is closed. The upper side is partially opened and, through its opening, the elements that fasten the panel to the rail are introduced. The opening of the lower rail is limited by the equidistant sides that partially close of the rail. It is on these sides that the 4 mm slots are made in such a way that they are equidistant to the longitudinal axle of the rail, and in which the Teflon strips attached to the lower frame sleeve are fitted. In this way, the weight of each panel rests over these Teflon strips. The inferior rail is attached to the floor similarly to the upper rail, with the help of a nail that goes through the longitudinal channel made along the lower rail axis.

That is, inside the trapezium a sheet metal is introduced, similar to the one in the upper side of the panel. Across this piece a warm screw is fitted; this worm screw includes, at least, two other elements that are introduced within the lower rail. These elements, together with the guide component and the worm screw, allow a fine adjustment of the panel in the lower rail in order to obtain an optimum assembly between the frame and the Teflon strips (PTFE) over which the weight of the panel rests, thus allowing an adequate movement of the panel. The structure of the door is slightly different to the rest of the panels, since at first it does not move along the rails. The upper end of the glass of the door is protected by an aluminum frame; the arms of said frame are attached to the glass and have a trapezium-shaped base, the upper side of which is open and corresponds to the large side, while the base is the small side and coincides with the base of the arms of the frame. Inside the trapezium, the sheet metal that goes through a worm screw is found, fastened by the plastic upper cylindrical guide made up of polyamide or a similar material. This guide has a section in the rectangular floor plan section with rounded corners, in order to enable the attachment of this component into the lower and upper guide. The inside part of this guide is hollow and circular, and the heads of two screws (the threads of which come out by the lower and upper opening) are located there. The upper opening in touch with the roof of the upper guide rail has a smaller diameter than the head of the screw that goes through the roof of the upper rail and threads in a nut located in the roof of the room. The other screw comes out through the lower opening, the circular side of which has a larger diameter than the heads of the screws; this allows the fitting of the heads of both screws within the piece. The lower side of the door contains the same elements arranged within the frame (the base of which is trapezoidal-shaped) and the lower guide rail. These lower and upper rails allow the rotation of the door in both ways and are in touch with the lateral sides of the open edge of the upper rail. With the help of the worm screw, the door can be fastened to the upper rail. As in the rest of the panels, these components are not sized to support the weight of the door, since the door shall rest in the base of the device.

On both the door and the panels, the upper side of the end that is opposite to the bending axle is made up by a wide-head screw that goes through a cylindrical hollow piece made up of polyamide and located in the upper rail hollow. This cylindrical guide piece has a diameter that coincides with the opening of the upper rail. The guide piece ends on its upper side with a widening of its inner thread in such a way that it coincides with the perimeter of the head of the screw. This screw goes through the hollow of the upper frame trapezium that protects the glass and is driven into a thread of the sheet metal located inside the upper frame trapezium. The sheet metal, consisting of stainless steel, is rectangular and has two threads equidistantly located along its longitudinal axle. On the other side, in the lower rail, the lower sides of the lower frame trapezium that protect the glass rest on the Teflon located in the channels of the lower rail. Moreover, a polyamide washer, with the shape of an “H”, is partially introduced between the sides that define the hollow of the lower frame trapezium in such a way that the base of the H-shaped washer covers the opening of the lower rail, without making the weight of the panel rest over the H-shaped washer in the inner borders that define the hollow of the lower rail. In this way, the washer does not rest over the Teflon strips, but it does cover the opening of the lower rail. The washer is attached to the frame with the help of a screw that goes across the threaded hollow through the longitudinal axle to the H-shaped washer and goes up to the base of the lower frame trapezium.

The central side of the upper rail that coincides with the door has a gap in which a mechanism based in a series of spoon-shaped recesses that house the heads of the T-shaped screws is located, so as to enable the rotation and opening of the panels when these are picked up in the end of the enclosure system.

In the upper rail side that coincides with the end of the door—opposite to the wall—a slot is made, in which an arm-shaped plate is placed. The hollow made in the upper rail allows the sheet and their frames to come out from the plan made up by the upper rails when these are picked up in the end of the enclosure system. The spoons, together with some plates that spread perpendicularly to the upper rail through the hollow made in said rail, enable the panels to rest and avoid them from bending.

The bending movement begins when the head of the T guide-screw is introduced and fitted within the spoon of the barrel located at the end of the rail, in the vicinity of the door. The sinking of the spoon establishes and secures the exact point through which the spin axle will pass and in which the spin movement of the door or panel will take place. Besides, the looseness of the sinking of the spoon allows a slight swinging of the door, which eases the opening of the panel or the door. When a panel bends, it twists through the spin axle comprised by the devices previously explained, and the sheet bends as well, driving the weight of the glass that the frame receives to the washer. When the H-shaped washer moves, it is moved above the lower rail opening, abandoning it for a notch made in the Teflon and dragging over the floor surface. On the other side, the axle and the guide that comprise the screw components that go through the guide piece can only abandon the upper rail through the hollow made near the wall.

The door includes a handle that allows the opening of the window fitted into the spin arm and that is used, together with the closure of the inner side, to open, close or block the door, thus allowing the system to be completely shut, without making it possible to open it from the outside.

In case you want to completely isolate a place with this enclosure system, the lateral finishing of each sheet shall be made of plastic or doormat, which will also be useful to cover the existing space between each sheet and panel, when the panels are spread. In turn, the lateral finishing of the panel that functions as door can also include a plastic stripe that will be used to close the space between the wall and the door. In case this system is used in terraces and to isolate outer spaces of buildings, it won't be always desirable to obtain a perfect isolation, and for this reason the finishing of the lateral sides will be decided according to each construction. In this sense, it is important to mention that one of the functions of these panels is to acoustically isolate the desired closed space from the outer noises, and in the tests that have been carried out it has been proved that the sound level perceived in the isolated room by the set of panels goes from 70 dB to 35 dB.

This system is prepared to support panels up to 3 meters high, in which each sheet can weight up to 50 kg. Moreover, the dimensions of the glass are limited to a width of 10 to 30 mm, because with these conditions and because of the use of the aluminum frames found of the market, it is possible to obtain the best mechanical behaviors for the system.

The movement and displacement of each panel is manually carried out by a person. The rotation and displacement of each panel will allow an easy cleaning of both faces. Besides, the maintenance of this structure is simple, because no wheels, bearings or drivings that might wear out are used.

The stripes over which each panel rests and moves along the rails are made up of Teflon (PTFE), since this material allows an easy movement of the panels, with mechanical properties resistant to abrasion and wear. These stripes are fixed to the lower section. The behavior of the Teflon (PTFE) in touch with the aluminum surfaces allows the simple and easy movement of the system.

### SHORT DESCRIPTION OF THE DRAWINGS

FIG. 1 represents a set of panels, including the door, spreading along the rails and defining a space.

FIG. 2 represents the set of panels picked up with a perpendicular positioning to the rail.

FIG. 3 represents the section of the panel or sliding sash through the vertical spin axis.

FIG. 4 represents the section of the panel or sliding sash through the disassembly axis.

FIG. 5 represents the section of the door of the enclosure system.

FIG. 6 shows a perspective view of the toughen glass frame.

FIG. 7 shows a perspective view of the lower rail.

FIG. 8 shows a perspective view of the upper rail.

FIGS. 9 and 10 show an elevation and floor plan view of the “T” screw.

FIGS. 11 and 12 show a section and floor plan view of the spin guide.

FIGS. 13 and 14 show a section and floor plan view of the cylindrical piece acting as a stop.

FIGS. 15 and 16 show a section and floor plan view of the guide piece.

FIGS. 17 and 18 show a section and floor plan view of said part.

FIGS. 19 and 20 show a section and floor plan view of the lower guide.

FIGS. 21 and 22 show a section and floor plan view of the guide piece that comes out through the hollow of the upper rail.

FIGS. 23 and 24 show a section and floor plan view of the cylindrical H-shaped component acting as washer.

FIGS. 25 and 26 show a section and floor plan view of the cylindrical piece located between the door frame and the panel rails.

FIGS. 27 and 28 show two different views of the barrel, element composed by the spoons of the spin mechanism.

### EXPLANATION OF A REALIZATION MODE

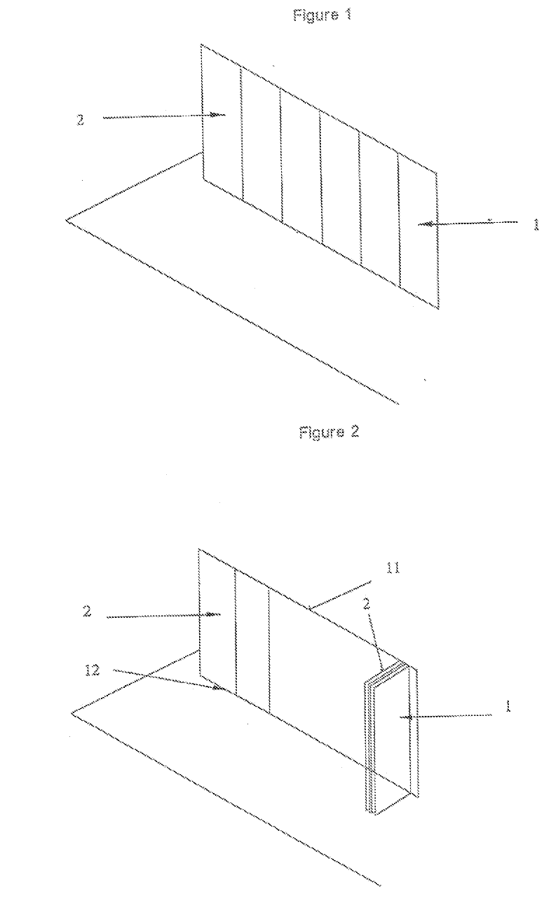

In FIGS. 1 and 2 we can see the way in which the set of panels (2) are distributed independently along the upper (11) and lower (12) rails. The door (1) is in the nearest position to the wall, which is the last one to spread. Some of the panels (2) are placed next to the wall perpendicularly and folded, since this is the only position in which it is possible to fold all the panels. Other panels are arranged along the rails (11 and 12), thus resulting in the space enclosure.

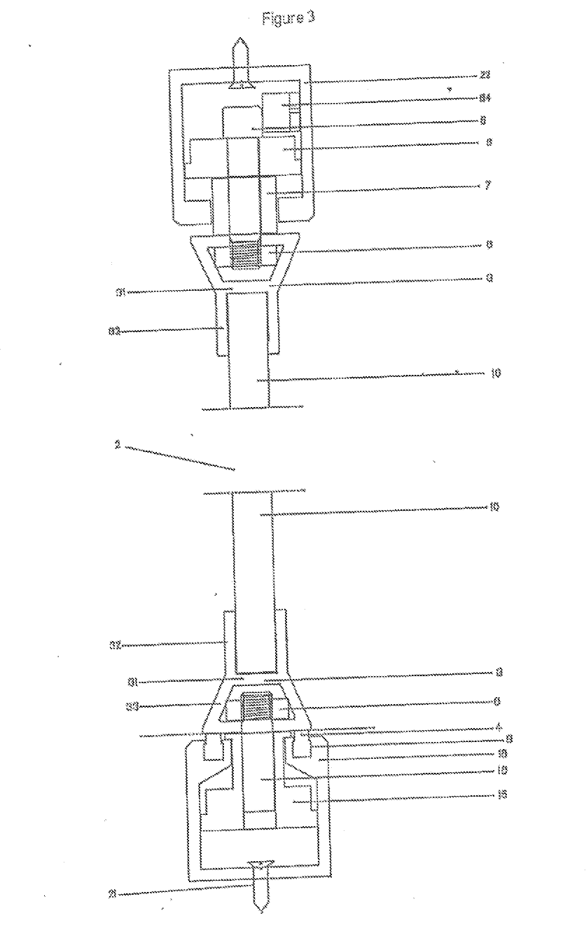

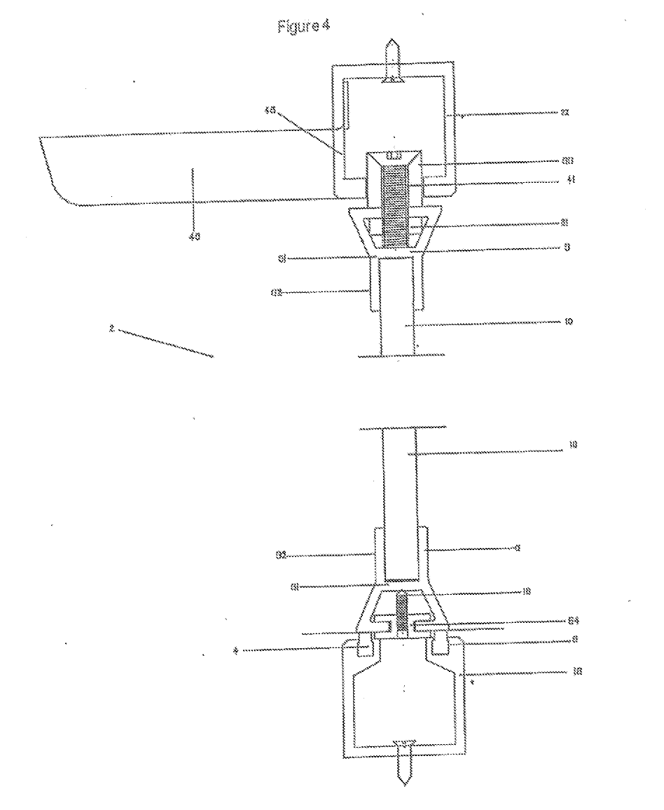

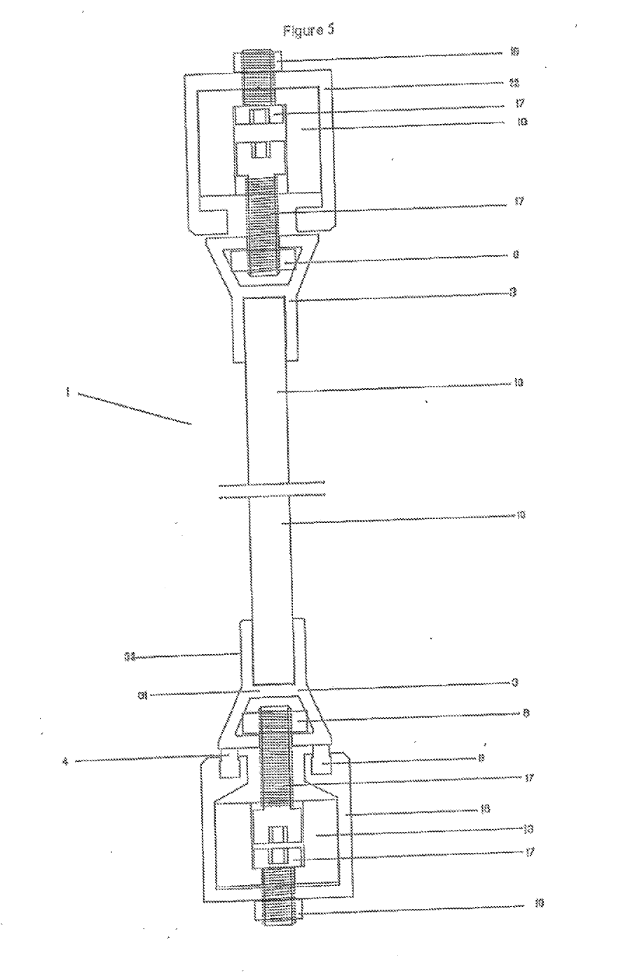

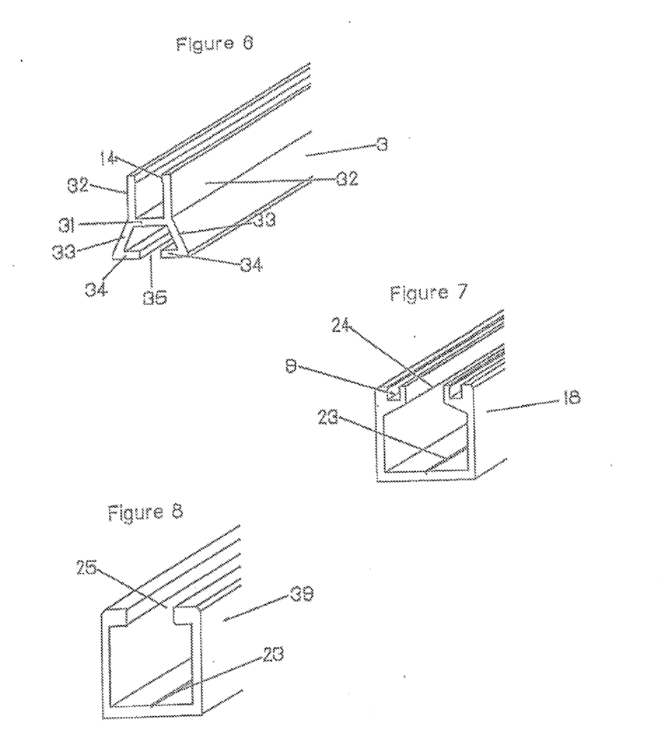

FIG. 3 shows a panel (2) composed by a toughen glass (10), between 10 and 30 mm wide, and the different devices included to allow the rotation of the sheet (2) over the spin axle. The glass upper end (10) is protected by an aluminum frame (3), the end arms (32) of which are attached to the glass (10) and to its base (31). As shown in more detail in figure six, the upper side of the frame (3) is trapezium-shaped, with an upper opening (35) located in the larger side of the trapezium and limited by both sides (34). The base (31) is the smaller side and it coincides with the ends of the frame (3) arms (32). The arms (32) end up with some small recesses (14) that improve the fitting of the toughen glass (10).

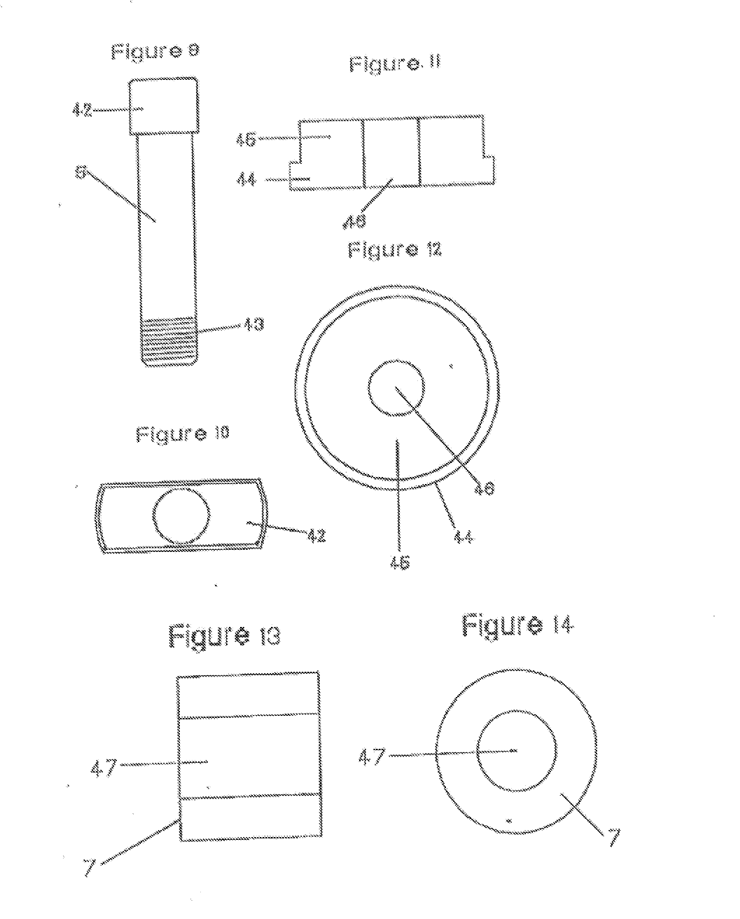

The rotation of the sheet or panel (2) is carried out with the help of some pieces partially located in the upper (11) and lower (12) guide rails. In this way, we will find three pieces in the upper side that make up the spin axle and the upper guide of the panel (2):
a) The T guide-screw (5), made up of stainless steel and with the shape of a “T”. In FIGS. 9 and 10 it is shown in detail that the head or upper end (42) of the screw (5) has the shape of an oval, with two straight and elongated sides so that, when it spins, it comes into contact with the inner side of the barrel (17) spoon (65), which delimits the movement of the T screw (5). The base of the T screw ends up in a screw cutting (43) that will allow the thread of this piece.
b) The spin guide (6) is made up of plastic; it has a circular shape and is located inside the rail (11). FIGS. 11 and 12 show that the guide (6) is a sole piece made up of polyamide or a similar material and it consists of two cylindrical “floors” of different size. The cylinder (44) that comprises the base of the guide (6) has a larger diameter and is in touch with the walls of the upper rail (11). The cylindrical upper floor (45) has a smaller diameter and both have a circular inner opening (46) that allows the entrance of the T guide (5), being the diameter of this circular opening (46) smaller than the lower width of the T guide-screw (5) head (42).
c) The third cylindrical piece (7), shown in FIGS. 13 and 14, is also made up of plastic, and it is the one in touch with the sides (34) of the frame (3) and the lower side of the cylinder (44) of the spin guide (6), acting as stop between them. It is also drilled on its axle to allow the entrance of the T guide-screw (5) through the hollow (47).

The spin guide (6) and the cylindrical piece (7) are crossed by the T guide-screw (5) through the openings (46 and 47, respectively.) The guide (5) head (42) is set with the spin guide (6), and the base of this T screw (5) goes through the hollow (35) of the trapezium (3) and is threaded in the upper sheet metal (8) located along the hollow inside the frame (3) trapezium. As it is shown in FIGS. 15 and 16, the upper sheet metal (8) is elongated and has three threaded hollows (37, 38 and 39), of identical diameter, located along the longitudinal axis of the piece (8). The sides of this piece (8) are straight, except for the one located at the end of the door or panel (2), which is curved. In the drill (37) made nearest to the curved side the T guide (5) is threaded, fastening the panel (2) to the upper guide (11), with the help of the spin guide (6) and the cylindrical piece (7). Thus, this upper sheet metal (8) aims to keep the frame (3) and the rail frame (11) stuck together, with the help of the set of pieces (5, 6 and 7). The upper sheet metal is placed in a determined place along the hollow (35) of the upper frame (3) with the help of two headless worm screws, not shown in the figures, which are threaded at the edges of the sides (34) as well as in the threads (38 and 39) of the sheet metal (8). The disposition of all these pieces is set throughout the T screw (5), in relation to the frame (11) of the panel. These components are not sized to support the weight of the sheet or panel (2), since it shall rest in the base of the device.

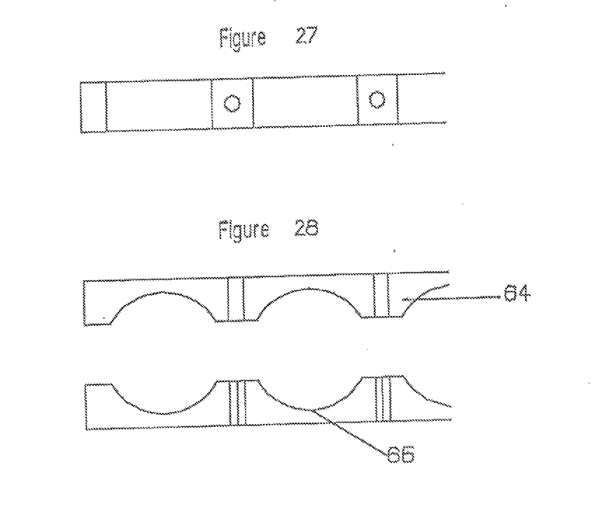

In FIG. 3 you can see, in the vicinity of the head (42) of the T screw (5), a partial cut of the piece called barrel (17), which is shown in detail in FIGS. 27 and 28). The T screw (5) is a straight and elongated piece, higher than the head (42) of the T screw (5), and it has a straight side in touch with the wall of the upper rail (11) to which it is attached with the help of some screws (not shown in respective figures) that go through the channels (66). The other side that looks into the rail (11) is made up by a set of curved gaps or valleys with the shape of a spoon (65) and prominences where the channels (66) end up. The piece (17) is located at the end of the rail that is in touch with the wall, and from there on it extends out along the upper rail (11). Its length and number of spoons (65) is defined by the number of panels (2) that make up the enclosure system, since each spoon (65) shall house the head (42) of the T screw (5) of each panel and it will help prevent that the panels bend when they are open. That is, each spoon (65) defines one of the points through which the axis in which each panel (2) rotates shall pass.

Thus, each barrel (17) is specifically made for each enclosure, depending on the number of panels that comprise the enclosure system, as well as the geometric characteristics of them, with the aim of establishing the point through which the spin axle shall pass.

As it is shown in detail in figure eight, the upper rail (11) has a rectangular or squared section; one of its sides is partially closed and has an opening that allows the entrance of the elements (5, 6 and 7) that constitute the upper side of the spin axle, which help to make the twist of the panels (2). The opening (25) is defined by the equidistant sides (30) of the rail (11). The upper rail (11) is attached to the roof by means of nails, screws or other similar elements (18) that drill a slot in the shape of a channel located in the inner face opposite to the opening (25) of the guide rail (11), since this channel (23) enables the introduction of the elements (18) that attach the rail (11) to the roof.

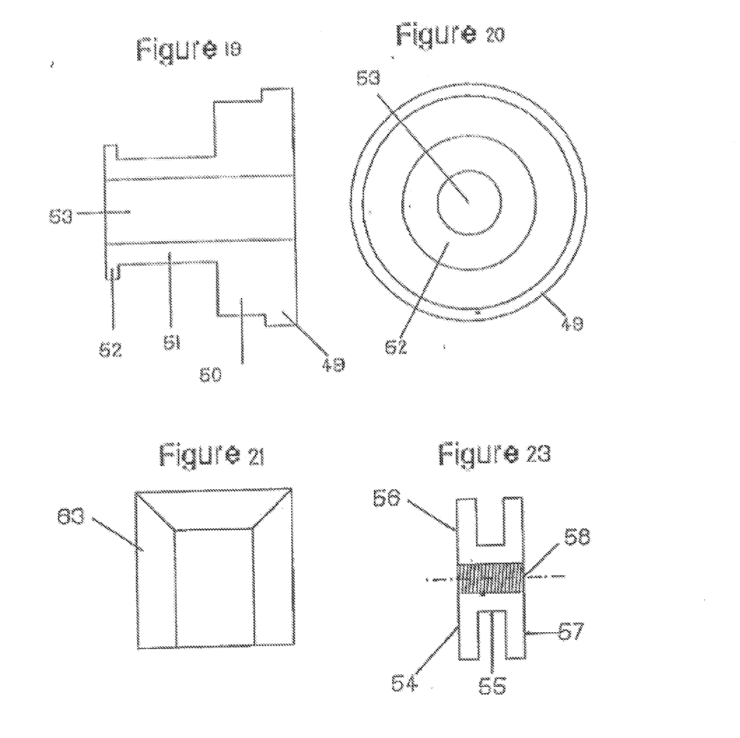

The lower side of the glass (10) is protected by an aluminum lower frame (3) similar to the upper one. The glass (10) is stuck to this frame (3) in the same way was it is stuck in the upper part. So, the upper side of the frame (3) includes the frame arms (32), the prominences (14) and the base (31) in which the weight of the glass rests (10). From the base (31) of the frame (3) some sides (33) come out; these constitute the trapezium and function as a mounting structure, since they rest on top of a sleeve (9) of the lower rail frame (12), which is also made up of aluminum. The lower side of the trapezium is open and corresponds to the larger side, whereas the base (31) corresponds to the smaller one. Within the trapezium there is a lower sheet metal (8) as in the upper side of the panel. A stainless steel screw (16) is driven into this piece (8), and it goes through the lower guide (15), made up of polyamide or a similar material, which allows the longitudinal movement along the lower rail (12). The rotation of the guide (15) inside the lower rail (12) allows the opening of the panels (2). FIGS. 19 and 20 show that this guide (15) is a sole piece and that it consists of four “floors” that make up the cylinders of different shape, the axle of which is hollow (53) so as to allow the entrance of the screw (16). The cylinder (49) that makes up the base of the lower guide (15) has the largest diameter and is in touch with the walls of the lower rail (12). Subsequently, there is another cylinder (50) that functions as step with the cylinder (49) and (51). Finally, on top of the cylinder (50) a fourth cylinder (52) protrudes, the diameter of which is slightly superior to the upper opening of the lower guide rail (12), in order to avoid the guide (15) from falling into the hollow of the lower rail (12). The guide (15) cylinder (51) is in touch with the end sides that make up the opening of the frame (3) trapezium, and it adapts to the upper opening of the lower guide rail (12).

With the screws (5 and 16) fastened in the different guides, it is possible to make the fine adjustment of the panel (2) between the lower (12) and the upper (11) rails.

As shown in detail in FIG. 7), the section of the upper rail is rectangular or squared, and its base is closed; the upper side is partially opened (24) and, through its opening, the elements of adjustment are introduced. The opening (24) of the lower rail (12) is limited by the equidistant sides that partially close the opening (24) of the rail (12). On these sides 4 mm gaps are drilled, in such a way that they are equidistant to the longitudinal axle of the rail, and in which the Teflon strips (4) attached to the lower frame sleeve are fitted. In this way, the weight of each panel (2) rests over these Teflon strips (4). The inferior rail is attached to the floor similarly than to the upper rail, with the help of a nail (19) or equivalent piece that goes through the longitudinal channel.

It is not foreseen that the door (1) moves along the lower and upper rails (11 and 12), reason why the structure of the door (1) is slightly different to the rest of the panels (2), as shown in FIG. 5. The upper end of the toughen glass (10) is protected by a frame (3) previously described, in which two end arms (32) are stuck to the glass (10) and to its base (31), which is trapezium-shaped. Inside the trapezium is the sheet metal (8), also previously described, to which a screw (27) is fastened, the head of which is found within the piece (13) that, in turn, is located inside the upper rail (11). In FIGS. 25 and 26 this piece is shown in detail (13), which is made up of polyamide or a similar material and that contains a rectangular floor plan section with rounded corners, in order to enable the attachment of this component into the lower and upper (11) guide. The inside part of this piece (13) is hollow and circular, and the heads of two screws (27 and 28) are located there; the threads of them come out by the lower and upper opening.

The upper opening (59), which is in touch with the roof of the upper guide rail (11), has a smaller diameter than the head of the screw (28) that goes through the roof of the side that makes up the upper rail (11) and is threaded in a nut (29) located in the roof of the room. The other screw (27) comes out through the lower opening (60), the circular side of which has a larger diameter than the heads of the screws (27 and 28), which allows the fitting of the heads of both screws within the piece (13). The lower side of the door contains the same elements arranged between the frame (3), the base of which is trapezoidal-shaped, and the lower guide rail (12), inside which you will find the rectangular floor plan section piece (13), which has rounded corners and is hollow, with an opening (59) that is in touch with the floor of the rail (12); this rail has smaller diameter than the head of the screw (28) that goes through it (12) and is threaded in the nut (29) located in the floor of the room, being the diameter of the exit (60) larger than the heads of the screws (27 and 28). On the other side, the head of the screw (27) is threaded in the sheet metal (8) located in the hollow of the trapezium (3).

This set of screws, nails (29) and piece (13), together with the sheet metal (8), enable the rotation of the door in both ways and is in touch with the lateral sides of the open side of the upper rail. With the help of the screw, the door can be adjusted to the upper rail. As in the rest of the panels, these components are not sized to support the weight of the door, since it shall rest in the lower sides (34) of the door frame which, in turn, rests on the Teflon stripes (4) located along the channels (9) in the base of the device.

The door (1) includes a handle (not shown in the figures), that allows the opening of the door; said handle is fixed in the spin arm and it is used, together with the closure of the inner side, to open, close or block the door (1), thus allowing the system to be completely shut, without making it possible to open it from the outside.

On the central side of the upper rail (11), that coincides with the end of the door (1), a gap is made opposite to the wall, and a mechanism is placed there; said mechanism is based in an arm-shaped plate (40) used to guide the exit of the sheets of the panels (2) and the door (1). That is, the slot (48) made in the upper rail (11) allows the sheets (10) and their frames (3) to come out from the plane made up by the upper (11) and lower (12) rails when these are picked up in the end of the enclosure system. The spoon (65) defines the axle on which each of the panel rotates, and the arm (40) will help each sheet (10) to come out, allowing them to rest on it. In this way, both elements (40 and 65) will prevent the panels from bending (2). Thus, when each panel (2) rotates on the spin axle made up by the devices (5, 6, 7, 8, 15 and 16) showed in FIG. 3, the sheet (10) bends, coming out of the plane composed by the upper (11) and lower (12) rails, with the help of the devices described below. The same occurs with the door (1) when it rotates on the spin axle made up by the devices (5, 6, 7, 8, 15 and 16), shown in FIG. 5.

The spoon-shaped plate (40) is inserted into the guide (11) gap, and it comes out perpendicularly into said upper rail (11) through the gap. On the end of the plate a rope is fastened (not shown in respective figures), which descends in parallel to the sheet (2) until it is adjusted to the lower rail (12).

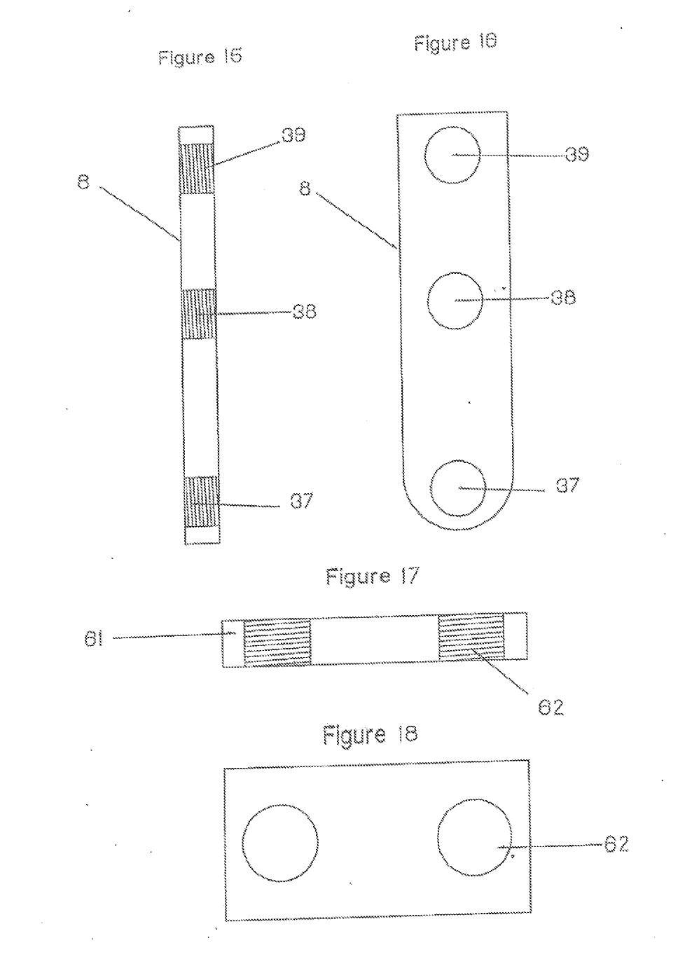

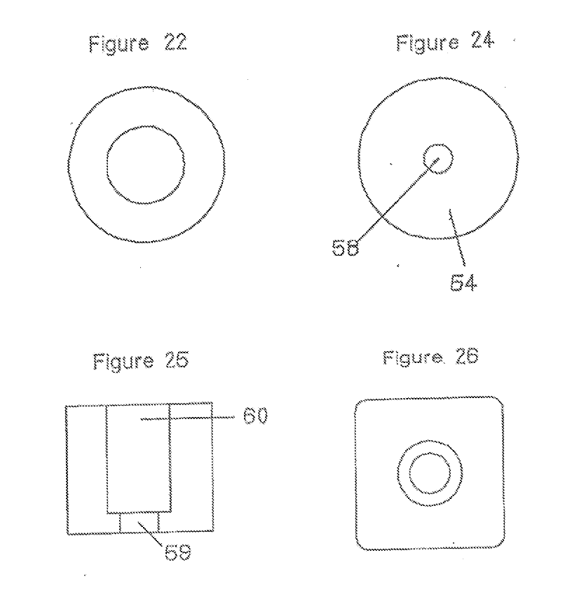

As it is shown in FIG. 4, the toughen glass (10) is fitted on the frame (3) previously described of the door (1) and the panels (2). For both the door (1) and the panels (2), the upper side of the end which is opposite to the bending axle comprises a wide head screw (41) that goes through a cylindrical hollow piece (63) made up of polyamide and located in the upper rail hollow (25). This cylindrical guide piece has a diameter that coincides with the opening of the hollow (25). The guide piece (63) is shown in more detail in FIGS. 21 and 22, where you can observe that the diameter of the inner cylinder allows the entrance of the screw (41). This hollow widens on the upper part of the piece (63) until it coincides with the perimeter of the screw head (41), making it fit on the piece (63) in order to enable the entrance of these pieces through the hollow (48) of the upper rail. The screw (41) goes through the hollow (35) of the frame (3) trapezium (35) and is fastened in the thread (22) of the sheet metal (21), which is housed inside the frame (3) trapezium. In FIGS. 17 and 18 you can see in more detail that the sheet metal (21) is rectangular and that it contains 2 threads (22) equidistantly located along its longitudinal axle. The sheet metal (21) is made up of stainless steel or any similar material. In the lower parts of the panels you can see that, over the Teflon (4) located in the channels (20) of the lower rail (12), the lower sides (34) of the frame (3) trapezium rest. Besides, a cylindrical washer (54) made up of polyamide and with the shape of an “H”, is partially introduced between the sides (34) of the frame (3) trapezium, in such a way that the base of the washer (54) covers the opening (24) of the lower rail, but without making the weight of the panel (2) rest over the washer (54) in the inner borders that define the hollow (24) of the lower rail (12). In this way, the washer does not rest over the Teflon strips (4), but it does cover the upper opening (24) of the rail (12). With the help of a screw (36) that goes across the threaded hollow (58) through the longitudinal axle to the washer (54) and up to the base (31) of the lower frame (3) trapezium, the washer (54) is fastened to the frame (3).

As it is shown in detail in FIGS. 23 and 24, the washer (54)—over which the sheet (2) moves and rotates—has the shape of an “H”, and it is a sole piece.

The said piece is divided into three cylinders: two outer cylinders (56 and 57) that have equal diameter—and which is larger than the one of the hollow of the lower rail (12)—and another inner cylinder (55), that has a much smaller diameter, which is inserted into the hollow (35) of the trapezium of the lower frame (3).

The bending movement begins when the head (42) of the T guide-screw is introduced and fitted within the spoon (65) of the barrel (17). The sinking (65) of the spoon establishes and secures the exact point through which the spin axle will pass and in which the spin movement of the door or panel will take place. Besides, the looseness of the sinking of the spoon (65) allows a slight swinging of the door, which eases the opening of the panel (2) or the door (1). When a panel (2) or door (2) bends, it twists through the spin axle comprised by the devices (5, 6, 7, 8, 15 and 16) and (8, 13, 27, 28 and 29), and the sheet bends as well, driving the weight of the glass (10) that the frame (3) receives to the washer (54) through its sides (33 and 34). When the washer moves (54), it is moved above the lower rail (12) opening (24), abandoning it for a notch (not shown in respective figures) made in the Teflon (4) and dragging over the floor surface. On the other side, the axle and the guide that comprise the screw pieces (41) that go through the cylindrical guide piece (63) and thread into the sheet metal piece (21), can only abandon the upper rail (11) through the hollow (48). Thus, the screw (41), the cylindrical piece (63) and the sheet metal (21) will be at a different distance on each panel (2), in such a way that the panels that were last to bend or be picked up will have the pieces (41, 21 and 63) nearest to the spin axle. So, the opposite end to the spin axle made up by the pieces (8, 13, 27, 28 and 29) of the door (1) coincides with the disassembly axle in which the pieces (41, 21 and 63) are located. Other solution consists on the size of each panel being different, so that the edge which is opposite to the spin axle coincides with the place where the guide pieces are placed (41, 21 and 63). A variant to this system consists of welding the T guide-screw (5) to (8) so as to get a higher robustness of the spin system for both the door (1) and the rest of the panels (2).

1. Enclosure system that comprises a set of independent panels or sheets (2) that move lengthwise through an upper (11) and a lower (12) guide rail; it consists of a device that rotates over an axle and a panel-door (1), and includes a rotation device on a fixed axle, characterized by a rectangular or squared upper rail (11) that has an opening (25) in its lower part, which is limited by two equidistant sides (30), and by the upper rail (11) been attached to the roof by means of nails or screws (18) that drill the channel (23) located along the opposite face to the opening (25) of the guide rail (11). The lower rail (12) has a rectangular or squared section. Its base is closed, and its upper side is partially opened (24); said opening (24) is limited by two equidistant sides that contain 4 mm gaps (20), in which some Teflon strips (4) (PTFE) are fitted. This rail (12) is attached to the floor by means of nails or screws (19) that drill the channel (26) located along the inner face opposite to the opening (24) of the guide rail (12), and each of the panels (1 and 2) consists of a toughen glass (10) stuck to the outer arms (32) that end up in some small recesses (14) and in the base (31) of a frame (3) that, on the other side, ends up in a hollow trapezium; said trapezium consists of an opening located on its larger side and it is limited by its sides (34), being the base (31) the smaller side. The spin axle of the panels (2) comprises the following pieces:
a) Three pieces on its upper side: a stainless steel T guide-screw (5) with the shape of a “T”; the head of which is oval and is located inside the upper rail (11); its body goes through the threaded opening (46). The spin guide is a sole piece made up of polyamide or a similar material and it consists of two “floors”. The cylinder of its base (44) has a larger diameter and is in touch with the walls of the upper rail (11), and the cylindrical upper floor (45) has a smaller diameter. The diameter of the threaded opening is smaller than the width of the head (42) of the T guide (5), as well as the plastic cylindrical piece (7), the diameter of which coincides with the opening of the upper rail. The upper rail is placed between the guide (6) and the sheet metal (8), located inside the frame (3) trapezium, which is rectangular and has 2 straight sides except for the one located at the end of the door or panel (2); this side is curved and contains 3 threaded hollows (37, 38 and 39) of identical diameter, located along the longitudinal axle of the piece (8). The screw (5) is driven into the threaded hollow (37) which is nearest to the curved side.
b) Two pieces in the lower side of the axle: a stainless steel screw (16) that goes through the lower guide (15); the lower guide is a sole piece made up of polyamide or a similar material, and it comprises four “floors” that make up the cylinders of different shape: its base is the cylinder (49) with the larger diameter and is in touch with the walls of the lower rail (12); the second floor consists of another cylinder (5) that functions as step; the third cylinder (51), the diameter of which coincides with the upper opening (24) of the lower guide rail (12); and the fourth floor is a cylinder (52) that protrudes from the cylinder (51), the diameter of which is slightly larger than the upper opening of the lower guide rail (12). The screw (16) is driven into the sheet metal (8) located inside the frame (3) trapezium. The upper side of the end opposite to the bending axle consists of a wide-head screw (41) that goes through a cylindrical hollow piece (63) made up of polyamide and located in the hollow (25) of the upper rail. Its diameter coincides with the opening of the hollow (25); the upper part of the piece (63) widens in such a way that it coincides with the perimeter of the head of the screw (41). This screw goes through the hollow (35) of the frame (3) trapezium and it is driven into the thread (22) of a sheet metal (21) located inside the upper frame (3) trapezium. The sheet metal (21), made up of stainless steel, is rectangular and has two threads (22) equidistantly located along its longitudinal axle. A cylindrical washer (54), made up of polyamide and with the shape of an “H”, comprises three cylinders, two of which are outer cylinders (56 and 57) and have an equal diameter—larger than the hollow of the lower rail (12)—, and another inner cylinder (55) with a smaller diameter, located inside the hollow (35); it is partially introduced between the sides (34) of the frame (3) trapezium, and the base of the washer (54) covers the opening (24) of the lower rail, without making the weight of the panel rest over the washer. A fine adjustment (36) screw goes through the threaded hollow (58) within the longitudinal axle to the washer (54) and up to the base (31) of the lower frame (3) trapezium.

2. Enclosure system according to claim 1, in which the door (1) is the last panel to spread. It does not move longitudinally; it is located at the end of the rail and is in touch with a wall; it also includes a closure system. The spin of the door (1) is made up by the sheet metal (8) located inside the frame (3) of the sheet (10), to which a screw (27) is fastened. The head of said screw is located within the piece (13) which, in turn, is housed inside the upper (11) and lower (12) rail. This piece (13) has a rectangular floor plan section with rounded corners, and it is made up of polyamide or a similar material. The inside of this piece is hollow and circular, and the heads of two screws (27 and 28)—the threads of which come out by the lower and upper opening—are located there. The upper opening (59) in touch with the roof of the upper guide rail (11) has a smaller diameter than the head of the screw (28) that goes through the roof and floor of the plane made up by the lower (11) and upper (12) guide, and which threads in a nut (29) located in the roof and floor of the room. The other screw (27) comes out through the lower opening (60), the circular side of which has a larger diameter than the heads of the screws (27 and 28); the upper side of the end which is opposite to the bending axle comprises a wide-head screw (41) that goes through a cylindrical hollow piece (63) made up of polyamide and located in the upper rail hollow (25). This cylindrical guide piece has a diameter that coincides with the opening of the hollow (25), and it widens on the upper side of the piece (63) until its width coincides with the perimeter of the head of the screw (41) that goes through the hollow (35) of the frame (3) trapezium and which is driven into the thread (22) of the sheet metal (21), which is made up of stainless steel or any similar material. The sheet metal (21) is housed inside the frame (3) trapezium; it is rectangular and that it contains 2 threads (22) equidistantly located along its longitudinal axle. The cylindrical washer (54), made up of polyamide and with the shape of an “H”, is a sole piece, and it is divided into three cylinders: two outer cylinders (56 and 57) of equal diameter—and larger diameter than the one of the hollow of the lower rail (12)- and another inner cylinder (55) of a much smaller diameter, which is inserted into the hollow (35); it is partially placed between the sides (34) of the frame (3) trapezium in such a way that the base of the washer (54) covers the opening (24) of the lower rail, without making the weight of the panel (2) rest over the washer (54). A fine adjustment screw (16) goes through the threaded hollow (58) within the longitudinal axle to the washer (54) and up to the base (31) of the lower frame (3) trapezium.

3. Enclosure system pursuant to claim 2, in which the door (1) and the panels (2) bend in a determined place. At the central part of the upper rail (11), which coincides with the end of the door (1) opposite to the wall a slot (48) is drilled; said slot needs to be long enough, in order to allow the housing of the whole set of panels when they bend. Within this slot (48), a metallic plate with the shape of an arm (48) is placed; it comes out perpendicularly to the upper rail (11) through the slot (48) and a rope is fastened to the end of the plate (40), which is located parallel to the plate (2) until it is adjusted to the lower rail (12).

4. Enclosure system pursuant to claim 3, in which the door (1) and the panels (2) bend in a determined place and in which the spin axle is determined by a barrel (17) located at the end nearest to the wall on which the door (1) rotates, and along the two sides of the upper rail (11). It is elongated and contains a series of spoon-shaped recesses (65) as in the panels that comprise the closure system and that bend at this end through the recess (48).

5. Enclosure system pursuant to claim 4 in which the Teflon strip (4) has a notch in the same position and with the same length than the recess (48); the screw (41), the cylindrical piece (63) and the sheet metal (21) are located at the panel (2) at such a distance that, when the panels bend, these will came out through the hollow (48), and the pieces (41, 42 and 43) of the last panels that will be picked up or bend will be nearest to the spin axle.

6. Enclosure system pursuant to claim 5 in which the size of each panel is different and coincides with the opposite end to the spin axle, where the guide pieces are found (41, 21 and 63).

7. Enclosure system pursuant to claim 4 in which each panel comprises a toughen glass between 10 and 30 mm thick; the panels of this system are up to 3 meters high, and each sheet can weight up to 50 kg.

8. Enclosure system pursuant to claim 4 in which the T guide-screw (5) is welded onto the sheet metal (8).

9. Enclosure system pursuant to claim 8 in which the door includes a handle that allows the opening of the window fitted into the spin arm, together with the operation of the closure system located inside the door.

10. Enclosure system for a total and complete isolation, pursuant to claim 9, in which the lateral finishing of each plate is made of sealing plastic or doormat, and which can also include a sealing plastic strip.

11. Enclosure system pursuant to claim 7, in which the movement and rotation of each panel is manually carried out by a person, and in which no wheels, bearings or drivings that might wear out are used.
